(19) United States
(12) Patent Application Publication
(10) Pub. No.: US 2026/0260870 A1
(43) Pub. Date: Sep. 3, 2026

(54) PROCESS FOR THE TRANSFORMATION OF COMMERCIAL SELENIUM SULFIDE (SeS2) TO HIGH PERFORMANCE BATTERY GRADED SULFUR-RICH SELENIUM SULFIDE CATHODE AND METHOD OF MAKING SAME

(71) Applicant: VALGOTECH LLC, Fishers, IN (US)

(72) Inventors: Md Sajibul Alam Bhuyan, Fishers, IN (US); David Olawale, Carmel, IN (US)

(21) Appl. No.: 19/358,492

(22) Filed: Oct. 15, 2025

Related U.S. Application Data
(60) Provisional application No. 63/765,539, filed on Mar. 1, 2025.

(51) Int. Cl. H01M 4/04; H01M 4/02; H01M 4/58; H01M 4/62; H01M 4/66; H01M 10/052

(52) U.S. Cl. CPC H01M 4/0483; H01M 4/0404; H01M 4/5815; H01M 4/623; H01M 4/625; H01M 4/661; H01M 4/663; H01M 4/667; H01M 10/052; H01M 2004/028

(57) ABSTRACT

A method for manufacturing high-performance sulfur-rich selenium sulfide (SeS₂₊ₓ, where x>0) cathode active material through transformation of commercial selenium sulfide. The method comprises heating SeS₂ to 110-185° C. to form a molten phase, adding elemental sulfur (at least 10% by weight) and stirring to achieve uniform crosslinking in the liquid phase, cooling to form a solid composite, and grinding into fine powder. The resulting material exhibits superior electrochemical performance with 1055 mAh/g specific capacity at C/10 rate, 65% capacity retention after 50 cycles, and reduced charge transfer resistance compared to elemental sulfur or conventional SeS₂. The invention includes cathode electrode composites with 40-80 wt. % sulfur loading, electrochemical cells, and batteries incorporating the novel cathode material for applications in portable electronics, electric vehicles, and grid-scale energy storage systems.

### CROSS-REFERENCE TO RELATED APPLICATIONS

This application claims the benefit of U.S. Provisional Application No. 63/765,539, filed Mar. 1, 2025, which is hereby incorporated by reference in its entirety.

### FIELD OF THE INVENTION

The disclosed technology relates generally to battery technology and energy storage systems. More specifically, the invention relates to cathode active materials for rechargeable batteries, particularly sulfur-rich selenium sulfide (SeS₊ₓ, where x>0) cathode materials, methods of manufacturing such materials through heat treatment and crosslinking processes, cathodes comprising these materials, and batteries incorporating such cathodes for enhanced electrochemical performance.

### BACKGROUND OF THE INVENTION

The demand for high-performance energy storage systems has grown exponentially with the proliferation of portable electronics, electric vehicles, and grid-scale energy storage applications. Lithium-sulfur (Li—S) batteries have emerged as promising candidates for next-generation energy storage due to the sulfur cathode's high theoretical specific capacity (1675 mAh/g), natural abundance, low cost, and environmental friendliness.

However, conventional sulfur cathodes suffer from several critical limitations that have hindered their commercial deployment. These include poor electrical conductivity (5×10⁻³⁰ S/cm at 25° C.), severe capacity fading due to the dissolution of lithium polysulfides into the electrolyte (known as the “shuttle effect”), large volume expansion (~80%) during lithiation, and sluggish reaction kinetics.

Selenium, a chemical analog of sulfur in Group VI, has been investigated as an alternative cathode material. While selenium offers improved electrical conductivity (1×10⁻³ S/m) and better reaction kinetics compared to sulfur, it suffers from a lower theoretical capacity (675 mAh/g), higher cost, toxicity concerns, and moisture sensitivity.

Selenium sulfide (SeS₂) has been explored as a compromise material, offering an intermediate theoretical capacity of 1342 mAh/g. In conventional SeS₂, with its molecular composition, selenium constitutes a larger mass fraction than sulfur due to selenium's higher atomic mass (78.96 g/mol) compared to sulfur (32.06 g/mol). This limits the overall capacity potential of the material.

Previous attempts to improve selenium sulfide cathodes have focused on carbon coating, nanostructuring, and electrolyte optimization. However, these approaches have not adequately addressed the fundamental limitation of insufficient sulfur content in the active material, nor have they provided economically viable manufacturing processes suitable for large-scale production.

Therefore, there exists a critical need for cathode materials that combine the high capacity of sulfur with the improved conductivity and stability of selenium-containing compounds, while maintaining cost-effectiveness and scalability for commercial battery applications.

### SUMMARY OF THE INVENTION

The disclosed technology addresses the aforementioned limitations by providing a novel sulfur-rich selenium sulfide cathode active material with the formula SeS₂₊ₓ (where x>0), and economically viable methods for its manufacture. The invention transforms commercially available selenium sulfide (SeS₂) into a high-performance, sulfur-enriched cathode material through controlled heat treatment and crosslinking processes.

In one aspect, the invention provides a method of manufacturing sulfur-rich selenium sulfide cathode material comprising: (a) heating commercial SeS₂ powder or granules to a temperature between 110° C. and 185° C. to form a molten phase with an open ring structure; (b) adding elemental sulfur to the molten SeS₂ and stirring to achieve uniform mixing and crosslinking; (c) cooling the mixture to form a solid sulfur-rich selenium sulfide composite; and (d) grinding and crushing the solid composite to produce granular powder suitable for cathode fabrication.

The resulting material exhibits superior electrochemical performance, delivering a specific capacity of 1055 mAh/g at C/10 rate, compared to 876 mAh/g for elemental sulfur and 730 mAh/g for conventional SeS₂. The material also demonstrates improved capacity retention (65% after 50 cycles, compared to 32% for elemental sulfur and 44% for conventional SeS₂), reduced charge transfer resistance, and enhanced rate capability at high current densities.

In another aspect, the invention provides cathode electrode composites comprising the sulfur-rich selenium sulfide active material mixed with conductive carbon additives and binders, wherein the sulfur loading ranges from 40 to 80 wt. % of the total electrode weight.

In yet another aspect, the invention provides electrochemical cells and batteries incorporating the novel cathode material, suitable for various energy storage applications including portable electronics, electric vehicles, and grid-scale storage systems.

### BRIEF DESCRIPTION OF THE DRAWINGS

FIG. 1 is a schematic illustration of the impregnation and crosslinking process of sulfur into host selenium sulfide according to an embodiment of the disclosed technology.

FIG. 2 is a flowchart depicting the process steps for manufacturing sulfur-rich selenium sulfide cathode active material according to an embodiment of the disclosed technology.

FIG. 3 is a photograph showing the visual comparison of starting materials and the final sulfur-rich selenium sulfide product according to an embodiment of the disclosed technology.

FIG. 4 shows scanning electron microscopy (SEM) images of (a) sulfur nanoparticles, (b) selenium sulfide (SeS₂), and (c) sulfur-rich selenium sulfide (SeS₂₊ₓ) according to embodiments of the disclosed technology.

FIG. 5 presents X-ray diffraction (XRD) patterns comparing sulfur, selenium sulfide, and sulfur-rich selenium sulfide according to embodiments of the disclosed technology.

FIG. 6 illustrates thermogravimetric analysis (TGA) curves of sulfur, selenium sulfide, and sulfur-rich selenium sulfide according to embodiments of the disclosed technology.

FIG. 7 shows the first charge-discharge voltage profiles comparing the cathode active materials at C/10 rate according to embodiments of the disclosed technology.

FIG. 8 presents electrochemical impedance spectroscopy (EIS) profiles comparing charge transfer resistance of different cathode materials according to embodiments of the disclosed technology.

FIG. 9 illustrates cycling performance comparison showing capacity retention over 50 cycles according to embodiments of the disclosed technology.

FIG. 10 demonstrates rate capability performance at different current densities (C-rates) according to embodiments of the disclosed technology.

### DETAILED DESCRIPTION OF THE INVENTION

The disclosed technology will now be described more fully with reference to the accompanying drawings and specific embodiments. This invention may, however, be embodied in many different forms and should not be construed as limited to the embodiments set forth herein.

### Terminology and Definitions

As used herein, “selenium sulfide” or “SeS₂” refers to the commercially available compound with a nominal Se:S ratio of 1:2, typically existing as a mixture of eight-membered ring structures.

“Sulfur-rich selenium sulfide” refers to the novel material of the disclosed technology having the formula SeS₂₊ₓ where x>0, indicating excess sulfur beyond the stoichiometric SeS₂ composition.

“Crosslinking” refers to the chemical bonding process wherein elemental sulfur integrates into the SeS₂ structure through nucleophilic attack on the ring structures during the molten phase.

“Active material” refers to the electrochemically active component of the cathode that participates in the charge storage mechanism.

### Chemical Structure and Mechanism

Commercial selenium sulfide (SeS₂) with purity >99.7% exists as eight-membered ring compounds with an overall Se:S ratio of 1:2. Based on the Lewis structure (S═Se═S), the central selenium atom is double-bonded to two sulfur atoms, with each sulfur atom having two lone pairs and the selenium atom having three lone pairs, resulting in a bent molecular geometry due to electron pair repulsion.

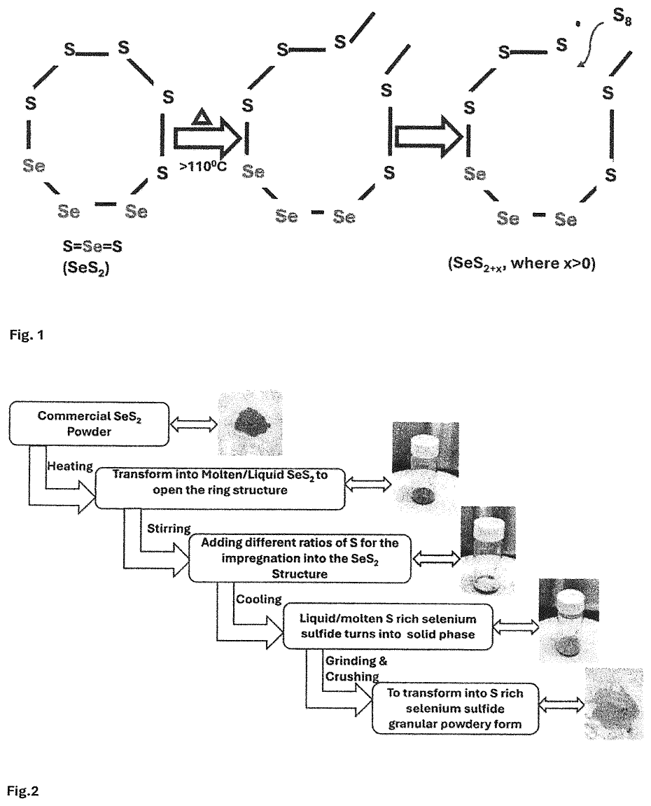

The melting point of SeS₂ exceeds 110° C., which facilitates opening of the ring structure upon heating. When SeS₂ is heated to form a molten phase, the ring structures become susceptible to nucleophilic attack. The addition of elemental sulfur (in particle, powder, or molten form) to molten SeS₂ initiates a crosslinking reaction wherein sulfur atoms integrate into the SeS₂ framework (see FIG. 1).

This integration process produces various binary chemical compounds of sulfur-rich selenium sulfide with the general formula SeS₂₊ₓ, where x>0. The value of x can be controlled by varying the weight ratio of elemental sulfur to SeS₂, with preferred embodiments having sulfur constitute at least 51% of the final composite by weight.

### Manufacturing Process

As shown in FIGS. 2 and 3, the method of manufacturing sulfur-rich selenium sulfide cathode material according to the disclosed technology comprises the following steps:
Step 1: Heating and Melting: Commercial SeS₂ powder or granules are heated to a temperature between 110° C. and 185° C., preferably between 130° C. and 150° C., most preferably at 140° C. The heating can be achieved through direct heating or indirect heating using an oil bath. This temperature is sufficient to convert the SeS₂ into a viscous, molten phase characterized by a dark reddish-black appearance. The molten state causes the eight-membered ring structures to open, making them reactive for subsequent sulfur integration.
Step 2: Sulfur Addition and Mixing: Elemental sulfur is added to the molten SeS₂ at predetermined weight ratios. The sulfur may be in powder or granular form with an average particle size less than 200 μm, preferably less than 100 μm. The weight ratio of sulfur to SeS₂ is at least 1:10, preferably 1:2 to 2:1, most preferably 1:1. The mixture is stirred at 200-500 rpm, preferably 350 rpm, for 1-60 minutes, preferably 5 -15 minutes, to ensure uniform mixing and complete crosslinking reaction. During this process, the mixture color transitions from dark reddish-black to light yellowish-brown.
Step 3: Cooling and Solidification: The molten mixture is cooled to room temperature (approximately 25° C.) over a period of up to 60 minutes, preferably 15-30 minutes. Natural cooling is preferred to maintain structural integrity. During cooling, the material transforms from a liquid to a solid crystalline phase. After fabrication, the orange tint color of selenium sulfide and light/lemon yellow color of sulfur transform into a characteristic sunflower yellow color of the sulfur-rich selenium sulfide composite.
Step 4: Grinding and Powder Formation: The solid sulfur-rich selenium sulfide is subjected to grinding and crushing through manual or mechanized means for up to 120 minutes, preferably 15-30 minutes. This process converts the bulk solid into fine granular powder suitable for cathode fabrication. The particle size can be further refined through ball milling, achieving microscale or nanoscale dimensions as required.

### Optional Additives

During the molten or stirring steps, various conductive polymer or copolymer additives may be incorporated to enhance electrical conductivity and structural stability. Suitable additives include but are not limited to: polyacetylene (PA), polyaniline (PANI), polypyrrole (PPy), polythiophene (PTH), poly(para-phenylene) (PPP), poly(phenylenevinylene) (PPV), polyfuran (PF), poly(3,4-ethylenedioxythiophene) (PEDOT), and 1,3-diisopropenylbenzene (DIB). These additives may be dispersed with the active material at up to 50% of the total weight of SeS₂.

### Material Characterization

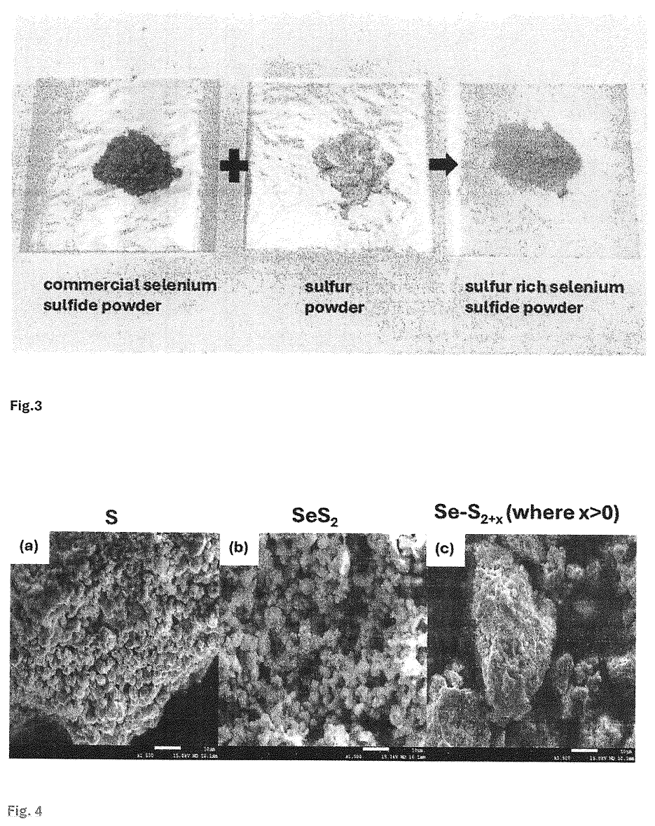

Morphological Analysis (SEM): As shown in FIG. 4, scanning electron microscopy reveals distinct morphological evolution during the transformation process. In the sulfur nanoparticles ((a) of FIG. 4), a compact granular morphology is observed, characterized by dense nanoparticle aggregation with limited porosity. This morphology contributes to structural stability but restricts electrolyte infiltration and is hindered by sulfur's intrinsically low conductivity. In contrast, selenium sulfide (SeS₂, (b) of FIG. 4) exhibits a more discrete and porous structure composed of irregular particles and interconnected voids. The selenium incorporation not only improves the intrinsic electronic conductivity but also facilitates electrolyte penetration and ion transport. However, its lower sulfur content limits the overall capacity. Upon deliberate addition of sulfur to generate the sulfur-rich SeS₂₊ₓ composite ((c) of FIG. 4) the morphology evolves into larger agglomerated particles with a layered and flaky texture. Compared to pristine SeS₂, the discrete particles become more clustered, and particle agglomeration is more pronounced, indicating the structural integration of sulfur within the SeS₂ framework. This transformation increases the sulfur loading, directly enhancing the theoretical capacity, while maintaining selenium's role in boosting conductivity and structural stability. The resulting sulfur-rich SeS₂ thus offers a synergistic combination of higher active material content and improved electronic/ionic pathways, enabling better polysulfide confinement and significant capacity enhancement compared to either sulfur or SeS₂ alone.

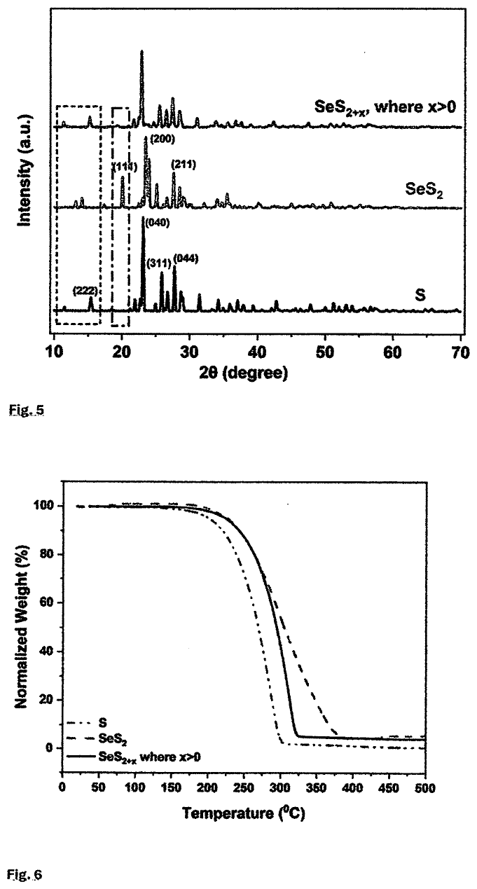

Structural Analysis (XRD) As shown in FIG. 5, the XRD patterns of sulfur(S), selenium sulfide (SeS₂), and sulfur-rich selenium sulfide (SeS₂₊ₓ, where x>0) clearly demonstrate the structural transformation upon sulfur integration. Pristine sulfur displays sharp orthorhombic reflections at (222), (040), (311), and (044) planes, indicating high crystallinity. SeS₂, in contrast, shows a monoclinic structure with characteristic peaks at (200), (211), and a distinct (111) reflection, absent in pure sulfur. Upon formation of sulfur-rich SeS₂ (SeS₂₊ₓ, where x>0), the (111) reflection vanishes, while sulfur-dominant features emerge. In particular, the strong peak at ~15.1°—analogous to that of crystalline sulfur—appears prominently in the sulfur-rich sample, providing further confirmation of sulfur incorporation within the SeS₂ framework. This combination of peak disappearance and new sulfur-related reflections indicates that sulfur becomes the dominant phase in the composite, validating the proposed synthetic strategy.

Thermal Analysis (TGA) As shown in FIG. 6, the TGA curves of sulfur(S), selenium sulfide (SeS₂), and sulfur-rich selenium sulfide (SeS₂₊ₓ, where x>0) exhibit distinct thermal stability trends that reflect their compositional differences. Pure sulfur shows a sharp weight loss between ~200-300° C., consistent with its low sublimation/decomposition temperature and volatile nature. SeS₂, in contrast, demonstrates a delayed and broader weight loss, initiating at a higher temperature range (~250-370° C.), indicating improved thermal stability due to selenium-induced stabilization incorporation. The sulfur-rich SeS₂ composite displays an intermediate behavior, with decomposition onset similar to sulfur (~230° C.) but extended stability toward higher temperatures (~320-340° C.), bridging the profiles of pure S and SeS₂. This suggests that while the added sulfur increases the active material content, the selenium framework partially stabilizes it, reducing volatility compared to pure sulfur. The combined effect confirms that sulfur-rich SeS₂, obtained through the synthesis process, maintains enhanced sulfur loading while benefiting from selenium's stabilizing role, a balance that is highly favorable for electrochemical applications requiring both high capacity and thermal stability.

### Cathode Electrode Fabrication

Cathode electrode slurries are prepared by mixing the sulfur-rich selenium sulfide active material with conductive carbon additives and binders. Suitable conductive additives include carbon black, microporous carbon, Ketjen black, single/multiwall carbon nanotubes, MXenes, 2D/3D graphene, and mixtures thereof.

The weight ratio of active material to conductive carbon components ranges from 30:70 to 90:10, preferably 60:40 to 80:20. Binders are added at 5-10 wt. % of the total electrode composition, with weight ratios of active material, conductive carbon components and binders, for example between 50:45:5 to 90:5:5. Suitable binders include both organic solvent-based and water-based systems: polyvinylidene fluoride (PVDF) in N-methylpyrrolidone (NMP), polyacrylic acid (PAA), polyvinyl alcohol (PVA), sodium carboxymethyl cellulose (CMC), styrene butadiene rubber (SBR), polytetrafluoroethylene (PTFE), polyacrylonitrile, chitosan, and mixtures thereof.

The slurry is coated onto carbon-coated aluminum foil current collectors using doctor blade, slot-die coating, or solvent-free dry processing techniques. The coated electrodes are dried under vacuum at 60-80° C. for 10-24 hours to remove residual solvents. Final sulfur loading in the cathode electrode composite ranges from 40 to 80 wt. % based on total electrode weight.

### Electrochemical Cell Assembly

Electrochemical cells incorporating the sulfur-rich selenium sulfide cathodes of the disclosed technology, and further include an anode, a separator, and an electrolyte. The anode may include ion reservoir materials including alkali metals (Li, Na, K), alkaline earth metals (Mg, Ca), transition metals, graphite, silicon, alloys, composites, and mixtures thereof. The separator may be provided in single or multilayer configurations of polypropylene (PP), polyethylene (PE), polyvinylidene fluoride (PVDF), cellulose, glass fiber, polytetrafluoroethylene (PTFE), nylon, ceramic-coated polymers, or solid-state electrolyte membranes. Finally, the electrolyte may be ether-based (DOL:DME with LiTFSI), carbonate-based (EC:DEC:DMC with LiPF₆), solid-state (polymer, ceramic, or composite), or ionic liquid electrolytes.

### Electrochemical Performance

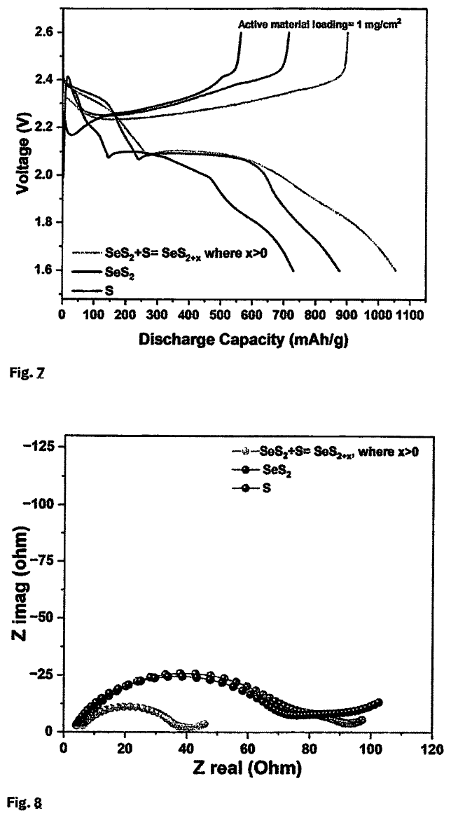

The sulfur-rich selenium sulfide cathode material of the disclosed technology demonstrates superior electrochemical performance compared to both elemental sulfur and conventional SeS₂. Specifically, as shown in FIG. 7, with regards to capacity it delivers 1055 mAh/g at C/10 rate with 1 mg/cm² loading, representing 20% improvement over sulfur (876 mAh/g) and 45% improvement over SeS₂ (730 mAh/g). The results of this testing indicate that the additional chemically bonded elemental sulfur of the material of the disclosed technology contributed to the capacity enhancement. Further, with regards to voltage profile, the novel cathode active material exhibits lower polarization than both elemental sulfur and selenium sulfide, confirming that lower polysulfide and lower polyselenide formation occurs during the electrochemical reaction.

As shown in FIG. 8, the impedance (EIS) profiles demonstrate that the charge transfer resistance of sulfur is higher compared to others due to its insulating and sluggish kinetic behavior. On the other hand, selenium's fast kinetics characteristic enhances ion diffusion and is associated with lower resistance. Most importantly, the present invention's active material shows the lowest charge transfer resistance among tested materials, indicating that the crosslinking chemical reaction reduces the impedance and improves ion diffusion into the cathode architectural design, confirming enhanced ion diffusion and electronic conductivity from the crosslinked structure.

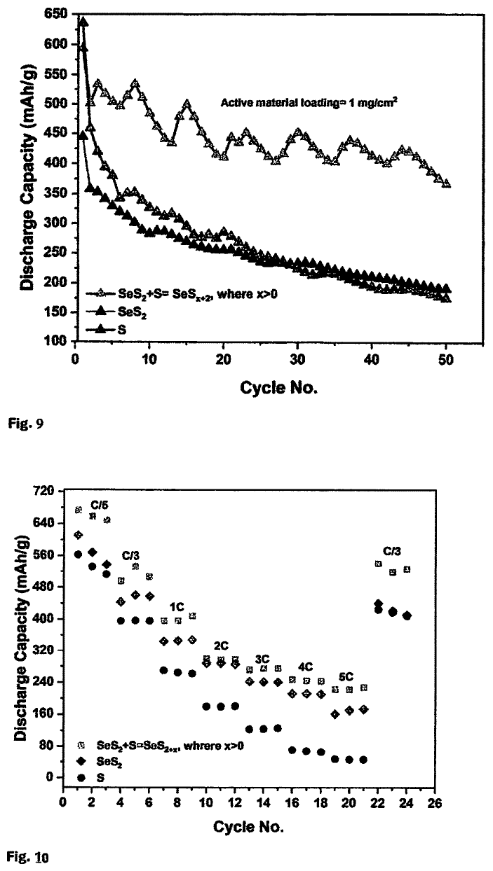

As shown in FIG. 9, the cyclic performance comparison of sulfur-rich selenium sulfide (SeS₂₊ₓ, where x>0) with elemental sulfur and selenium sulfide demonstrates that the material maintains cycling stability with a 65% capacity retention after 50 cycles, compared to 32% for sulfur and 44% for SeS₂. Both sulfur and selenium sulfide show rapid capacity fading due to shuttle effects and high polarization. On the contrary, the invented cathode active material exhibits stable cyclability, demonstrating superior structural stability and reduced active material dissolution.

As shown in FIG. 10, different current density performance comparison with different cathode active materials demonstrates rate capability. Due to the shuttle effect and sluggish ion transportation, elemental sulfur cathode material showed very poor rate performance in high current density at 5 C. On the other hand, the present invention exhibited significant improvement in the high C rate, over both elemental sulfur and selenium sulfide. The cathode material of the disclosed technology sustains high capacity at elevated current densities up to 5 C, while elemental sulfur shows poor performance due to shuffle effects and sluggish kinetics. The presence of selenium, structural stability, and lower impedance enhanced the rate-boosting effect of the novel cathode material, enabling superior high-rate performance.

### EXAMPLES

The following examples illustrate specific embodiments of the invention but should not be construed as limiting the scope thereof.

### Example 1

### Synthesis of 1:1 Sulfur-Rich Selenium Sulfide

A 30 mL glass vial was charged with 800 mg of commercial selenium sulfide powder (>99.7% purity). The vial was heated to 140° C. for 10 minutes, converting the powder into a viscous dark reddish-black liquid. Subsequently, 800 mg of elemental sulfur powder (200 mesh) was added to the molten SeS₂ and the mixture was stirred at 350 rpm for 5 minutes. The resulting light yellowish-brown mixture was allowed to cool naturally for 15 minutes, forming a solid crystalline phase. The solid was manually ground for 15 minutes to produce fine granular powder, then ball-milled with graphene powder at a 4:1 ratio for 10 minutes.

### Example 2

### Cathode Fabrication and Cell Assembly

The cathode active material from Example 1 was mixed with graphene, conductive carbon black, and polyvinylidene fluoride (PVDF) binder in a weight ratio of 80:10:10 in N-methylpyrrolidone solvent. The slurry was mixed for 15 minutes and coated onto carbon-coated aluminum foil using a doctor blade applicator. The coated foil was dried in a vacuum oven at 60° C. for 10 hours. Circular electrodes (12 mm diameter) were punched and assembled into CR2032 coin cells with lithium metal anodes, Celgard 2325 separators, and 1 M LiTFSI in DOL:DME (1:1 v/v) electrolyte in an argon-filled glove box.

### Example 3

### Electrochemical Testing

Coin cells from Example 2 were tested using a Gamry Reference 3000 potentiostat for impedance measurements and a LANDT CT2001A battery testing system for galvanostatic cycling, as shown in FIGS. 7-10. Specifically, cells delivered 1055 mAh/g initial discharge capacity at C/10 rate and maintained 65% capacity after 50 cycles. Impedance spectroscopy confirmed charge transfer resistance of 45Ω, significantly lower than sulfur (98Ω) and SeS₂ (105Ω) control cells.

What is claimed is:

1. A method of manufacturing a sulfur-rich selenium sulfide cathode active material having the formula SeS₂₊ₓ where x>0, comprising:
heating selenium sulfide (SeS₂) to a temperature sufficient to form a molten phase;
adding elemental sulfur to the molten SeS₂ and mixing to form a uniform molten mixture wherein the sulfur crosslinks with the SeS₂;
cooling the molten mixture to form a solid sulfur-rich selenium sulfide composite; and
grinding the solid composite to form a granular powder cathode active material.

2. The method of claim 1, wherein the SeS₂ is in powder or granular form having a purity of at least 99%.

3. The method of claim 1, wherein the heating temperature is in the range of 110° C. to 185° C.

4. The method of claim 1, wherein the mixing is performed by stirring at 200 to 500 rpm for 1 to 60 minutes.

5. The method of claim 1, wherein the heating is achieved by direct heating or through an oil bath medium.

6. The method of claim 1, wherein the elemental sulfur is in powder or granular form having an average particle size less than 200 μm.

7. The method of claim 1, wherein the weight ratio of the elemental sulfur to the SeS2 is at least 1:10.

8. The method of claim 1, wherein the sulfur-rich selenium sulfide contains at least 51% elemental sulfur by weight.

9. The method of claim 1, further comprising adding one or more conductive polymer additives during the mixing, wherein the additives are selected from the group consisting of: polyacetylene, polyaniline, polypyrrole, polythiophene, poly(para-phenylene), poly(phenylenevinylene), polyfuran, poly(3,4-ethylenedioxythiophene), and 1,3-diisopropenylbenzene.

10. The method of claim 9, wherein the additives comprise up to 50% by weight of the total SeS₂.

11. A cathode electrode composite comprising:
a sulfur-rich selenium sulfide cathode active material having the formula SeS₂₊ₓ where x>0, manufactured according to the method of claim 1;
one or more conductive carbon additives selected from the group consisting of carbon black, microporous carbon, Ketjen black, carbon nanotubes, MXenes, graphene, and mixtures thereof; and
one or more binders.

12. The cathode electrode composite of claim 11, wherein the weight ratio of the active material to the conductive carbon additives is from 30:70 to 90:10.

13. The cathode electrode composite of claim 11, wherein the one or more binders are selected from the group consisting of: polyvinylidene fluoride, polyacrylic acid, polyvinyl alcohol, sodium carboxymethyl cellulose, styrene butadiene rubber, polytetrafluoroethylene, polyacrylonitrile, chitosan, and mixtures thereof.

14. The cathode electrode composite of claim 11, wherein the weight ratio of active material: conductive carbon additives: binders is from 50:45:5 to 90:5:5.

15. The cathode electrode composite of claim 11, having a sulfur loading from 40 wt. % to 80 wt. % based on the total weight of the cathode electrode composite.

16. The cathode electrode composite of claim 11, wherein the composite is coated on a carbon-coated aluminum foil current collector.

17. An electrochemical cell comprising:
a cathode comprising the cathode electrode composite of claim 15;
an anode;
a separator; and
an electrolyte.

18. The electrochemical cell of claim 17, wherein the electrolyte is selected from the group consisting of ether-based, carbonate-based, solid-state, and ionic liquid electrolytes.

19. The electrochemical cell of claim 17, wherein the separator comprises one or more materials selected from the group consisting of: polypropylene, polyethylene, polyvinylidene fluoride, cellulose, glass fiber, polytetrafluoroethylene, nylon, and ceramics.

20. The electrochemical cell of claim 17, wherein the anode comprises an active material selected from the group consisting of: alkali metals, alkaline earth metals, transition metals, graphite, silicon, alloys, composites, and mixtures thereof.
